(19) United States
(12) Patent Application Publication
(10) Pub. No.: US 2014/0291168 A1
(43) Pub. Date: Oct. 2, 2014

(54) MULTIPLE POTENTIAL BASED CHRONOAMPEROMETRIC FREE CHLORINE SENSORS

(71) Applicant: NANOSELECT, INC, Wilmington, DE (US)

(72) Inventors: Chunhong Li, Chester Springs, PA (US); Lin Zhang, Wilmington, DE (US)

(73) Assignee: Nanoselect, Inc., Wilmington, DE (US)

(21) Appl. No.: 14/357,095

(22) PCT Filed: Nov. 8, 2012
(86) PCT No.: PCT/US2012/064067

§ 371 Date: May 8, 2014

Related U.S. Application Data
(60) Provisional application No. 61/558,986, filed on Nov. 11, 2011.

(51) Int. Cl. G01N 27/30

(52) U.S. Cl. CPC G01N 27/308; Y10S 977/957; Y10S 977/746; B82Y 15/00
USPC 205/778.5; 205/787.5; 205/786.5; 205/782; 205/785.5; 205/781; 204/412; 977/957; 977/746

(57) ABSTRACT

A chronoamperometric method and device to determine concentration of an electrochemically active species in a fluid and pH of the fluid. A plurality of sets of calibration relationships may be determined for a sensor in an aqueous solution, the sensor having one or more working electrodes and one or more reference electrodes. A first plurality of potentials may be applied across the working and reference electrodes of the sensor in solution, and a first plurality of currents and current differences obtained as a function of the applied first plurality of potentials. Concentration of an electrochemically active species may then be determined as a function of the obtained first plurality of currents and current differences using the plural sets of calibration relationships, and pH of the solution may be determined as a function of the obtained first plurality of currents and current differences using the plural sets of calibration relationships.

### CROSS REFERENCE TO RELATED APPLICATIONS

The present application is co-pending with and claims the priority benefit of the provisional application entitled “Multiple Potential Based Chronoamperometric Free Chlorine Sensors,” Application Ser. No. 61/558,986, filed on Nov. 11, 2011.

### FIELD OF DISCLOSURE

The disclosed system and method generally relate to a layer-by-layer surface functionalization of carbon nanostructures. More specifically, the disclosed system and method relate to layer-by-layer surface functionalization of carbon nanostructures and the application of such functionalized carbon nanostructures as sensing elements for measuring, monitoring, analyzing and testing free chlorine concentration in aqueous solutions.

### BACKGROUND

Chlorine is generally employed to disinfect drinking water. The Environmental Protection Agency (EPA) mandates that residual free chlorine concentration in drinking water be in the range of approximately 0.2 mg/L to 4 mg/L. Thus, free chlorine concentration should be continuously monitored and controlled to achieve effective disinfection of drinking or tap water while minimizing adverse health effects thereto.

Various methods have been developed to test residual free chlorine concentration in water. For example, the DPD (N,N-diethyl-p-phenylenediamine) method has become a standard in the water industry for free chlorine measurement. In an exemplary DPD method, chlorine-containing samples are reacted with N,N-diethyl-p-phenylenediamine sulfate in the presence of a suitable buffer. The indicator and buffer are added in a combined powder form and react with chlorine to produce a pink color whereby the resulting compound is measured using an LED-based spectrophotometer. Such a method, however, utilizes multiple reagents, and the adverse health effects of these reagents and their subsequent disposal have become a concern. Further, as the DPD method requires the reagents to completely react with residual free chlorine in water, each measurement takes at least 1 minute. Thus, an online, continuous free chlorine sensor which would not require the use of any reagent is needed in the art.

Most online free chlorine sensors are chronoamperometric sensors with a hydrophobic membrane covering the electrodes in an electrolyte solution. Chronoamperometry is generally an electrochemical technique in which the potential of a working electrode is stepped and the resulting current at the electrode caused by the step is monitored. Typically, gold is employed as the working electrode to electrochemically reduce free chlorine. There are, however, several issues related to a chronoamperometric type of membrane-based free chlorine sensor. For example, free chlorine may exist in aqueous solution as Cl₂, HOCl and/or OCl⁻ depending upon solution pH, and each of these noted species have different diffusion rates across a hydrophobic membrane. Therefore, the use of a hydrophobic membrane determines that these online probe sensors are pH-dependent. It follows that only when the solution pH is known can the sensor reading be calibrated to give an accurate free chlorine concentration. Therefore, a pH sensor is also required for these online chronoamperometric free chlorine sensors. Additionally, it should be noted that hydrophobic membranes also change its respective permeability at different temperatures towards these free chlorine species, and flow rate or turbulence of the sample solution may determine how fast these free chlorine species cross the membrane to reach an electrode. Fouling of the membrane may also contribute to a drift in free chlorine response of these membrane-based online free chlorine sensors, and the membrane probes cannot withstand pressure which reduces their effectiveness in water pipes. Finally, the electrolyte solution in conventional probe sensor should be replaced every one or two months, and the sensors require periodic calibration depending upon their usage.

Therefore a need exists in the art for a chronoamperometric free chlorine sensor based on a functionalized multi-walled CNT electrode that may be readily constructed and provide a high sensitivity for free chlorine species in solution. There also exists a need in the art for a well-controlled surface functionalization of carbon nanostructures without altering the superior properties of such carbon nanostructures to provide exemplary nanostructures for chronoamperometric and other industry usages. Thus, it is desirable to overcome the limitations of the prior art and provide a carbon nanostructure having functionalized layers and utilize such structures as sensors and the like.

### SUMMARY

Embodiments of the present subject matter provide utility in the field of sensors for residual free chlorine in aqueous solutions. Free chlorine concentration may be determined based upon simultaneous chronoamperometry at multiple reductive potentials or cyclic multistep chronoamperometry. Further, in embodiments of the present subject matter both free chlorine concentration and solution pH may be concurrently determined. While the following disclosure provides a discussion directed to chlorine concentrations, the claims appended herewith should not be so limited as concentrations of other species may also be determined.

In one embodiment, a free chlorine sensor is provided based upon functionalized carbon nanotube (CNT) electrode. The functionalized CNT electrode may be in direct contact with the testing solution whereby no hydrophobic membrane is required. An exemplary electrode surface according to embodiments of the present subject matter may resist fouling and can therefore continuously function in water for an extended period of time. In another embodiment, the functionalized CNT electrode may be employed as an array of microelectrodes to eliminate sensor dependence on flow. To overcome the pH dependence of free chlorine response, one embodiment of the present subject matter may provide a multiple potential-based chronoamperometric approach to concurrently determine both solution pH and combined free chlorine concentration in aqueous solution without a pH meter.

In one embodiment of the present subject matter a chronoamperometric method of determining concentration of an electrochemically active species in a fluid and pH of the fluid comprising is provided. The method includes the steps of determining a plurality of sets of calibration relationships for a sensor, the sensor having one or more working electrodes and one or more reference electrodes. The sensor may be placed in an aqueous solution, and a first plurality of potentials applied across the working and reference electrodes of the sensor. A first plurality of currents and current differences may then be obtained as a function of the applied first plurality of potentials, and a concentration of an electrochemically active species determined as a function of the obtained first plurality of currents and current differences using the plural sets of calibration relationships. pH of the solution may also be determined as a function of the obtained first plurality of currents and current differences using the plural sets of calibration relationships.

In another embodiment, a device for measuring an electrochemical species in a fluid and pH of the fluid is provided. The device may include a reference electrode in communication with a fluid, an auxiliary electrode, and a sensing electrode in communication with the fluid. The sensing electrode may include one or more carbon nanostructures functionalized with a chemically stable moiety that measures concentration of an electrochemical species when a potential is applied across the reference and sensing electrodes to thereby provide a current between the sensing and auxiliary electrodes, the current correlating to the concentration of the electrochemical species and to the pH of the fluid.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a schematic illustration of an exemplary layer-by-layer approach to provide surface functionalization to a CNT and carbon nanostructure.

FIG. 2 is a plot of current versus free chlorine concentration in solutions at pH 5, 7, 9 and at potentials of 0.1V, 0.05V and 0V.

FIG. 3 is a plot of current difference versus free chlorine concentration in solutions at different pH and varying potentials.

FIG. 4 is a block diagram of one embodiment of the present subject matter.

FIG. 5 is a schematic illustration of an exemplary sensor according to one embodiment.

### DETAILED DESCRIPTION

With reference to the figures, where like elements have been given like numerical designations to facilitate an understanding of the present subject matter, the various embodiments of multiple potential based chronoamperometric free chlorine sensors are described.

While carbon nanotubes (CNTs) are generally regarded as a superior electrode material, grown CNTs are typically hydrophobic. Reference is made to specific CNTs herein, however, the claims appended herewith should not be so limited as it is envisioned that embodiments of the present subject matter are applicable to any type CNT such as, but not limited to, single-walled CNTs (SWCNT), multi-walled CNTs (MWCNT), conductive, semi-conductive, or insulated CNTs, and chiral, achiral, open headed, capped, budded, coated, uncoated, functionalized, anchored, or unanchored CNTs, and the like.

Hydrophobicity may generally make CNTs unsuitable for aqueous applications. Embodiments of the present subject matter, however, may chemically modify a CNT surface to impart a certain degree of hydrophilicity. Additionally, the use of CNTs as an electrode material is challenging as good contact between the CNT and a conductive surface or electric lead structure must be established. In this regard, CNTs have been used in a composite format with carbon powder on glassy carbon as an electrode material; however, such a mixture of CNT with carbon powder and a composite binder may result in uncertain electrical properties for the CNT.

Embodiments of the present subject matter may grow CNTs on a substrate with an established electric contact. For example, a metal catalyst such as, but not limited to, nickel on top of a titanium adhesion/barrier layer may be deposited on a silicon substrate and annealed at a high temperature to form small catalyst particles. Of course, any type of metal catalyst may be employed in embodiments of the present subject matter and the claims appended herewith should not be limited to the example above. Using chemical vapor deposition techniques, CNTs may grow from the catalyst particles and establish electric contact between the grown CNT and substrate. In co-pending International Application No. PCT/US2010/056350, entitled, “Protection and Surface Modifications of Carbon Nanostructures,” having an international filing date of Nov. 11, 2010, the entirety of which is incorporated herein by reference, the use of an alkyl protective moiety forming an alkyl protective moiety layer to protect the metal catalyst particles (i.e., the electric contact between CNT and substrate) is described. This application generally describes a carbon nanostructure employed as an electrode for the determination of free chlorine and total chlorine concentrations in water.

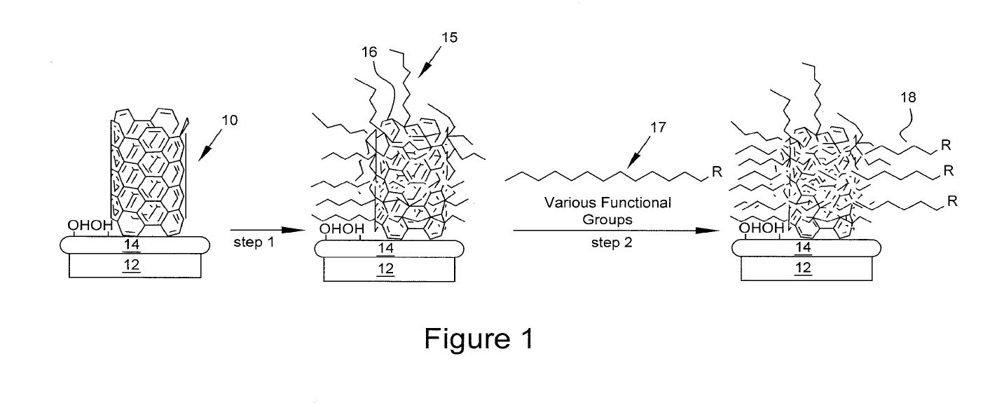

FIG. 1 is a schematic illustration of an exemplary layer-by-layer approach to provide surface functionalization to a CNT and carbon nanostructure. With reference to FIG. 1, to exploit the superior properties of CNTs, embodiments of the present subject matter may covalently attach additional functional groups or functional moieties such as redox mediators and enzyme molecules on top of an exemplary protective layer for the detection of other analytes of interest using a layer-by-layer approach. In step one, grown CNTs 10 on a substrate 12 may be contacted with a composition comprising an alkyl protective moiety under conditions that permit the formation of an alkyl protective layer 15 disposed directly adjacent to at least a portion of the metal catalyst 14 and/or the carbon nanotubes 16. An exemplary alkyl protective moiety may include, but is not limited to, a compound such as an alkane. Non-limiting examples of alkanes include n-octadecane, n-dodecane, eicosane and hexatriacontane. Of course, these examples of alkanes should not limit the scope of the claims appended herewith. The alkyl protective layer 15 may have a thickness in the range of, for example, from about 1 nm to about 500 nm, about 10 nm to about 300 nm, about 50 nm to about 250 nm, or about 50 nm to about 100 nm. At this stage, the CNT surface having the first protective layer 15 may be hydrophobic.

One non-limiting method for the deposition of the first hydrophobic protective layer on an exemplary CNT nanostructure on a substrate may include depositing a solution comprising n-octadecane onto CNTs on a silicon substrate using standard procedures. Upon drying the solvent in air, the treated sample may be placed in a small vial and the vial purged with an Argon stream and then securely capped. This capped vial may be heated, and the sample then cooled to ambient temperature in the capped vial. The sample may then be removed from the vial with forceps and rinsed with THF before drying in air. At this stage, the CNT may be highly hydrophobic with the alkyl protective layer (first layer) in place. Of course, this exemplary method should not limit the scope of the claims appended herewith and is presented simply for representative purposes only.

In step two, other functional groups 17 and functional moieties may then be introduced above this first protective, hydrophobic layer 15, leading to the formation of a second layer 18. One non-limiting method for the second layer functionalization of a CNT nanostructure on a substrate may include providing a CNT nanostructure on a silicon substrate with the first alkyl protective layer in place followed by depositing a solution of bipolar molecules or a mixture of bipolar molecules with desired functional groups or functional moieties onto the first layer. Upon drying the solvent in air, the treated sample may be placed in a small vial and the vial purged with an Argon stream and then securely capped. This capped vial may be heated, and the sample cooled to ambient temperature in the capped vial. The sample may then be removed from the vial with forceps and rinsed with a solvent to remove excess deposition before drying in air. Again, this exemplary method should not limit the scope of the claims appended herewith and is presented for representative purposes only. With the second layer in place, the CNT nanostructure on the substrate may be used as an electrode if no additional functional groups derivatization is required.

In one embodiment, it may be advantageous to use a bipolar molecule (or a mixture of bipolar molecules) where favorable hydrophobic-hydrophobic interaction assists the anchoring of the bipolar molecule onto the first layer 15 with the polar groups exposed for additional manipulation if necessary. Exemplary bipolar molecules are described in co-pending International Application No. PCT/US12/054,399 filed Sep. 10, 2012 and International Application No. PCT/US12/060,197 filed Oct. 15, 2012, the entirety of each being incorporated herein by reference.

In a further embodiment, the bipolar molecule may be a compound similar to the compounds represented in co-pending International Application Nos. PCT/US12/054,399 and PCT/US12/060,197 but may also include more than two sub-units connected with multiple linker groups. For example, a bipolar molecule having three sub-units connected with two linker groups in a linear manner may be utilized. It should be appreciated by those skilled in the art that a bipolar molecule with three or more sub-units may be connected with three or more linker groups to form a macro-ring structure as well and such examples should not limit the scope of the claims appended herewith.

Through judicious selection of an exemplary chemical structure of the bipolar molecule, embodiments may introduce an array of functional groups onto a CNT surface above the hydrophobic alkyl protective layer 15. For the CNT nanostructure to be a useful electrode material with long-term stability in aqueous applications, the functionalized CNT surface should, however, be resistant to non-specific adsorption. Additionally, for many surface electrochemical reactions that require participation of H⁺, OFF or H₂O, the functionalized CNT surface should also be highly hydrophilic.

Polyethylene glycol may generally resist non-specific adsorption when deposited on a surface and may render a respective surface hydrophilic to a certain degree. Polyoxyethylene alkyl ethers may also be suitable to be deposited above the hydrophobic alkyl protective layer or first layer 15 on an exemplary CNT to form a hydrophilic polyethylene glycol layer or second layer 18. Exemplary polyoxyethylene alkyl ethers include, but are not limited to, tetraethyleneglycol monooctyl ether (designated as C8EG4), hexaethyleneglycol monododecyl ether (C12EG6), heptaethyleneglycol monohexadecyl ether (C16EG7) and commercially available detergents, identified by the trade names Brij®30 (C12EG4), Brij®52 (C16EG2), or Brij®56 (C16EG10), Brij®58 (C16EG20), Brij®35 (C12EG30), Brij®78 (C18EG20), Brij®S 100 (C18EG100), Brij®S 200 (C18EG200) (Croda International PLC, East Yorkshire, England).

Embodiments of the present subject matter may employ a myriad of processes to synthesize exemplary bipolar molecules having various functional groups and functional moieties. Several such processes are described in co-pending International Application Nos. PCT/US12/054,399 and PCT/US12/060,197, the entirety of each being incorporated herein by reference.

With continued reference to FIG. 1 and the exemplary processes described in PCT/US12/054,399 and PCT/US12/060,197, a CNT nanostructure may be functionalized using a layer-by-layer approach, i.e., forming a first protective (e.g., alkyl) layer followed by a second layer of polyoxyethylene alkyl ether or other layer. These embodiments may be employed as an electrode for free chlorine or other species concentration determination in an aqueous solution such as, but not limited to, tap water.

It is known that free chlorine exists in aqueous solutions as multiple species depending on solution pH as illustrated in the relationships below.

Cl₂+H₂O [symbol] HCl+HOCl (1)

HOCl+H₂O [symbol] H₃O⁺+OCl⁻ (2)

The predominant species for free chlorine in drinking water exists as HOCl and OCl⁻. For example, between pH 4 and pH 6 more than 95% of free chlorine exists as HOCl, and as pH increases from pH 7 to pH 9, the percentage of HOCl in solution quickly diminishes to less than 10%. Per EPA regulations, most drinking water has a pH in the range of 6.5 to 8.5. Thus, it is clear that the distribution of HOCl and OCl⁻ varies greatly in drinking water. Such variations in the distribution of HOCl and OCl⁻ may pose a challenge for amperometric free chlorine measurements as HOCl and OCl⁻ have significantly different reactivities. For example, OCl⁻ is thermodynamically less reactive than HOCl in receiving electrons evidenced by the large difference in their standard reductive potentials, E⁰ (See Equations 3 and 4 below). Further, negatively charged OCl⁻ may not readily accept electrons than HOCl.

HOCl+H⁺+2e⁻ [symbol] Cl⁻+H2O E⁰=1.49 V (3)

Cl⁻+H2O+2e⁻ [symbol] Cl⁻+2OH⁻ E⁰=0.90 V (4)

Amperometric reduction of free chlorine is generally a kinetic process. The reductive current at a given potential is proportional to the reaction rate of HOCl and OCl⁻ reduction on an electrode. Thus, for a given solution with a combined free chlorine concentration c the following relationship may be made:

c=[HOCl]+[OCl⁻] (5)

Using Equations (3) and (4), the rate of HOCl reduction (R₁) and OCl⁻ reduction (R₂) may be written as follows:

R₁=k₁[HOCl][H⁺] (6)

R₂=k₂[OCl⁻] (7)

Therefore, total reductive current at a given potential may be proportional to the total reduction rate R of both HOCl and (O)ᵣ.

R=R₁+R₂=k₁[HOCl][H⁺]+k₂[OCl⁻] (8)

From Equation 2, the dissociation constant Kₐ of HOCl may be represented as:

Kₐ=[H⁺][OCl⁻]/[HOCl] (9)

The concentration of OCl⁻ may then be expressed as:

[OCl⁻]=Kₐ[HOCl]/[H⁺] (10)

Thus, the combined free chlorine concentration c may be given by the relationships below.

c=[HOCl]+Kₐ[HOCl]/[H⁺] (11)

R=k₁[HOCl][H⁺]+k₂Kₐ[HOCl]/[H⁺] (12)

To solve for combined free chlorine concentration c, both [HOCl] and [H⁺] are required. Based upon the relationship provided in Equation (12), the unknowns cannot be mathematically solved with one equation. The reduction of free chlorine, however, may be carried out at multiple reductive potentials and thus multiple sets of reaction constants k may be obtained. Thus, the unknowns described above may be determined with two or more equations. For example, at given potentials A, B, and C the reduction current may be expressed as:

Rₐ=k₁ₐ[HOCl][H⁺]+k₂ₐKa[HOCl]/[H⁺] (13)

R_{b}=k_{1b}[HOCl][H⁺]+k_{2b}Ka[HOCl]/[H⁺] (14)

R_{c}=k_{1c}[HOCl][H⁺]+k_{2c}Ka[HOCl]/[H⁺] (15)

For a solution having a combined free chlorine concentration c and [H⁺], both free chlorine concentration c and solution pH may be determined based on two or more current readings by employing Equations (13)-(15). For example, two or more CNT working or sensing electrodes may be connected to two or more floating potentiostats. In this example, each working or sensing electrode may require its own potentiostat but share a common reference electrode and/or counter electrode. Each of the working electrode potentials may then be set versus the shared reference. Since each potentiostat is floating, the current flow for each potentiostat would be independent of the others. Using this exemplary system architecture, two or more reduction currents may be obtained simultaneously and/or continuously. In another embodiment, a cyclic multistep chronoamperometry may be employed with one CNT working or sensing electrode whereby a predetermined set of potentials is applied to the CNT working or sensing electrode in sequence for a predetermined duration in cycles. In this example, the system architecture would require a single potentiostat.

In practice, a set of calibration curves may be obtained at potentials P₁, P₂ and/or P₃ at different solution pH with various free chlorine or other species concentrations. Generally, there should be one calibration curve for each solution pH at each potential, however, embodiments should not be so limited. For example, embodiments may also obtain a calibration curves at every 0.5 pH increment from pH 5 to pH 9 to accommodate most drinking water pH changes. Further, calibration curves for smaller pH increments such as, but not limited to, 0.1 pH may also be obtained mathematically based on approximation. Such exemplary calibration curves may be stored and used for calculation of combined free chlorine concentration and solution pH according to embodiments of the present subject matter. By way of a non-limiting example, each calibration curve at any given pH can be expressed as a quadratic equation:

Y=AX²+BX+C (16)

where Y represents the current reading at a given potential and X represents combined free chlorine concentration. The root X (i.e., the combined free chlorine concentration) may then be expressed as:

$$X = \frac{- B + \sqrt{{B}^{2} - 4 A ( C - Y )}}{2 A} \qquad ( 17 )$$

Thus, at a given pH (e.g., pH of 5) and at a potentials P₁, P₂, and P₃, the current reading at these potentials may be represented as:

Y₁=A₁X²+B₁X+C₁ (18)

Y₂=A₂X²+B₂X+C₂ (19)

Y₃=A₃X²+B₃X+C₃ (20)

It follows that the current difference Y₂−Y₁ and Y₃−Y₂ may be obtained using the relationships below.

Y₂−Y₁=(A₂−A₁)X²+(B₂−B₁)X+(C₂−C₁) (21)

Y₃−Y₂=(A₃−A₂)X²+(B₃−B₂)X+(C₃−C₂) (22)

Thus, for each given solution pH one may expect a set of five calibration curves (see, e.g., Equations (18)-(22)) if three different potentials are used. Employing actual calibration and mathematical approximations, one may obtain approximately forty sets of five calibration curves for solution pH between 5 and 9 for each 0.1 pH increment whereby each set of five curves is associated with a known solution pH. Thus, when a solution having an unknown pH and unknown combined free chlorine concentration X is tested at potentials P₁, P₂ and P₃ simultaneously, the currents Y₁, Y₂, Y₃ and current differences (Y₂−Y₁), (Y₃−Y₂) may be used in approximately forty sets of calibration equations to determine the combined free chlorine concentration X. As each solution may have one pH and one combined free chlorine concentration at any given time, all five roots from each set of five equations would be equal. Thus, the set of five equations that yield the same root may then determine the combined free chlorine concentration. Further, as each set of five equations is associated with a known solution pH based upon earlier calibrations, the pH of the testing solution may also be determined. In another embodiment, when two potentials are used simultaneously there would be a set of three calibration curves for each solution pH, and the combined free chlorine concentration would be similarly determined.

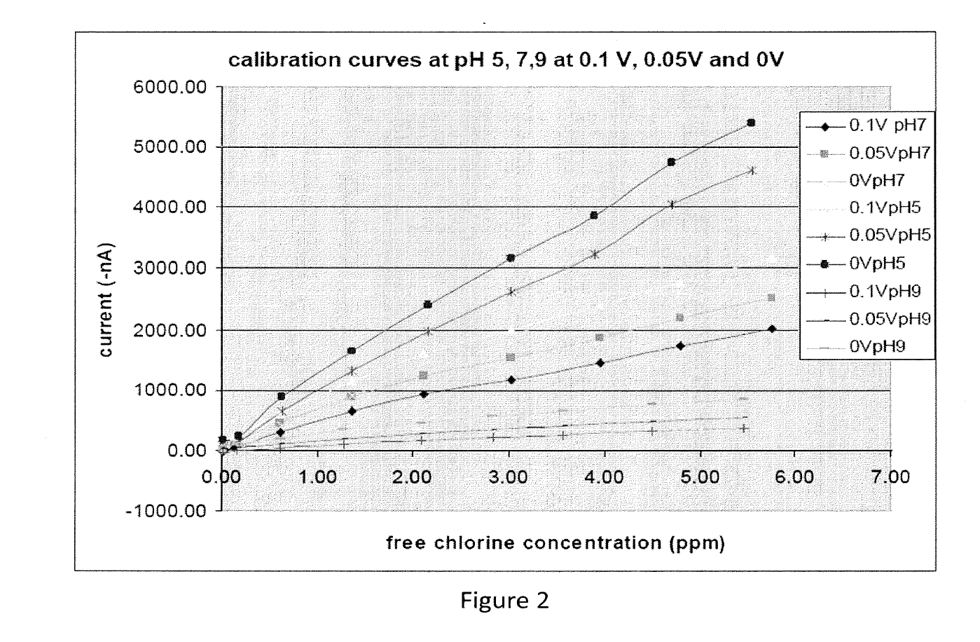

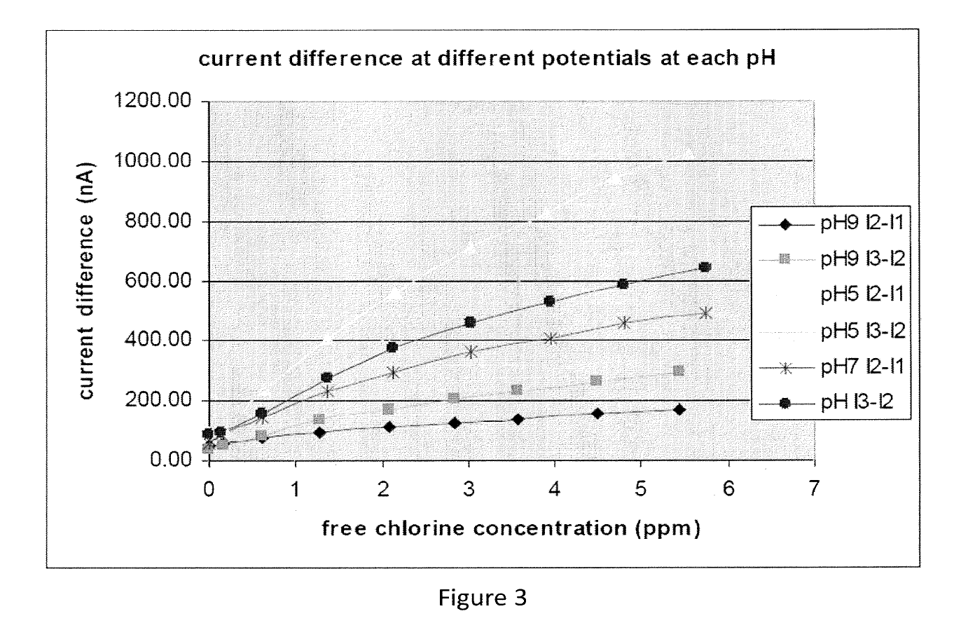

In one embodiment, an exemplary CNT array of electrodes may be employed using cyclic multistep chronoamperometry at a plurality of potentials to generate calibration curves. FIG. 2 is a plot of current versus free chlorine concentration in solutions at pH 5, 7, 9 and at potentials of 0.1V, 0.05V and 0V. FIG. 3 is a plot of current difference versus free chlorine concentration in solutions at different pH and varying potentials. With reference to FIG. 2, cyclic multistep chronoamperometry with three difference potentials (0.1V, 0.05V and 0V) was applied to generate the calibration curves illustrated therein. To generate the results depicted in FIG. 2, a Reference 600 potentiostat 5.61 (Gamry Instruments, USA) was utilized with an exemplary CNT array of electrodes having a three-electrode configuration. The configuration included a Ag/AgCl reference electrode, an auxiliary electrode, and a CNT nanostructure on a silicon substrate as the working or sensing electrode in a polydimethylsiloxane (PDMS) flow cell. The Ag/AgCl reference electrode was centered approximately 3 mm above the CNT nanostructure working electrode. The CNT working electrode was functionalized via an exemplary layer-by-layer process and then exposed to flowing tap water with various free chlorine concentrations. The pH of the flowing tap water solution was monitored with a glass electrode HQ30d flexi pH meter and adjusted in a reservoir with dilute HCl or NaOH solutions upon constant stirring. To generate the results depicted in FIG. 3, the current difference at each pH was then generated and plotted against solution free chlorine concentration to yield the plot depicted in FIG. 3. Based upon the plots shown in FIGS. 2 and 3, a set of five equations were obtained for each solution pH as provided in the tables below.

TABLE 1
Calibration equations at pH 5 and calculation results of unknown solution
pH 5

| | | | Calculated |
|---|---|---|---|
| | | Current data | free chlorine |
| | Equations from | from unknown | concentration |
| | calibration curves | solution | (ppm) |
| P1 = 0.1 V | y = 1.0107x² + | 104.67 | 0.2103 |
| | 647.18x − 31.462 | | |
| P2 = 0.05 V | y = −14.046x² + | 197.67 | 0.1669 |
| | 900.78x + 47.732 | | |
| P3 = 0 V | y = −23.577x² + | 333.33 | 0.1712 |
| | 1073.8x + 150.24 | | |
| Current | y = −15.057x² + | 93.00 | 0.0546 |
| difference | 253.6x + 79.193 | | |
| I2 − I1 | | | |
| Current | y = −9.5303x² + | 135.00 | 0.1899 |
| difference | 172.99x + 102.5 | | |
| I3 − I2 | | | |

TABLE 2
Calibration equations at pH 7 and calculation results of unknown solution
pH 7

| | | | Calculated |
|---|---|---|---|
| | | Current data | free chlorine |
| | Equations from | from unknown | concentration |
| | calibration curves | solution | (ppm) |
| P1 = 0.1 V | y = −19.622x² + | 104.67 | 0.2231 |
| | 456.91x + 3.7051 | | |
| P2 = 0.05 V | y = −28.973x² + | 197.67 | 0.2206 |
| | 583.59x + 70.356 | | |
| P3 = 0 V | y = −39.383x² + | 333.33 | 0.2548 |
| | 740.67x + 147.19 | | |
| Current | y = −10.41x² + | 93.00 | 0.1037 |
| difference | 157.08x + 76.832 | | |
| I2 − I1 | | | |
| Current | y = −9.351x² + | 135.00 | 0.5629 |
| difference | 126.68x + 66.651 | | |
| I3 − I2 | | | |

TABLE 3
Calibration equations at pH 9 and calculation results of unknown solution
pH 9

| | | | Calculated |
|---|---|---|---|
| | | Current data | free chlorine |
| | Equations from | from unknown | concentration |
| | calibration curves | solution | (ppm) |
| P1 = 0.1 V | y = −4.8687x2 + | 104.67 | 1.3815 |
| | 99.42x − 23.387 | | |
| P2 = 0.05 V | y = −7.0467x2 + | 197.67 | 1.3844 |
| | 132.75x + 27.391 | | |
| P3 = 0 V | y = −11.999x2 + | 333.33 | 1.4044 |
| | 205.78x + 68.002 | | |
| Current | y = −2.178x2 + | 93.00 | 1.3938 |
| difference | 33.328x + 50.778 | | |
| I2 − I1 | | | |
| Current | y = −4.9522x2 + | 135.00 | 1.4314 |
| difference | 73.031x + 40.611 | | |
| I3 − I2 | | | |

After the calibration equations provided in Tables 1, 2 and 3 above were obtained, the exemplary CNT array electrode was employed to test a solution with unknown pH and unknown free chlorine concentration following an exemplary cyclic multi-step chronoamperometry procedure to yield three currents of 104.67 nA, 197.67 nA and 333.33 nA at 0.1V, 0.05V and 0V, respectively. By using each current and the respective current differences into each individual calibration equation, three sets of concentration data may be produced. Thus, as described above, since a given solution can have only one free concentration and one solution pH at any given time, the data provided demonstrates that the solution should have a combined free chlorine concentration of 1.39 ppm with a solution pH of 9. Therefore, the utility of an exemplary CNT nanostructure electrode as a chronoamperometric sensor is evident, and such an exemplary sensor may find use in aqueous solutions with various analyte concentrations as well as solutions under pressure. It should be noted that the tables and examples provided above are exemplary only and are presented simply for representative purposes only.

One exemplary method of fabrication of an electrode according to an embodiment of the present subject matter includes providing or fabricating the underlying silicon chip, growing or depositing appropriate carbon nanostructures such as CNTs, and functionalizing the surface of such nanostructures. For example, one exemplary method of silicon chip fabrication is described in International Application No. PCT/US07/02104, the entirety of which is incorporated herein by reference. In this method, an insulating layer (e.g., SiO₂ or the like) may be deposited on top of a silicon substrate. An exemplary conductive layer may then act as an interconnect for CNT nodes. A barrier layer (e.g., Ti or the like) may be deposited on the conductive layer area to prevent segregation of subsequent catalyst material from the conductive layer. A thin catalyst layer (e.g., Ni, Fe or Co, etc.) may then be deposited and patterned by conventional lithography to form nodes of catalyst in a defined geometric shape (e.g., circle, rectangle, strips, etc.) with appropriate insulating layers (SiO₂, Si₃N₄, etc.) surrounding the nodes of catalyst.

Exemplary CNTs as described herein may then be grown on the underlying substrate by any number of methods including, but not limited to, an exemplary chemical vapor deposition (CVD) process described in PCT/US07/02104 and may be, in one embodiment, undoped aligned CNTs assemblies. Other methods may include an exemplary arc discharge process, laser-ablation process, natural, incidental and/or controlled flame environments, plasma enhanced chemical vapor deposition, a capacitively coupled microwave plasma process, a capacitively coupled electron cyclotron resonance process, a capacitively coupled radiofrequency process, an inductively coupled plasma process, a dc plasma assisted hot filament process, template synthesis, carbo thermal carbide conversion, or combinations thereof, to name a few.

For example, the CNTs may include an electrically conductive layer covering a portion or all of a substrate and may include an assembly of undoped CNT antennae vertically oriented with respect to the electrically conductive layer. Any or each of the undoped CNT antennae may include a base end attached to the electrically conductive layer, a mid-section having an outer surface surrounding a cavity or channel therein (i.e., lumen), and a top end disposed opposite the base end. In one embodiment, the outer surface of the mid-section may be in fluidic contact with an environment (e.g., a liquid solution) that is in contact with the CNT antennae.

The CNTs may then be functionalized as described herein and in co-pending International Application Nos. PCT/US2010/056350, PCT/US12/054,399 and PCT/US12/060,197 the entirety of each incorporated herein by reference. Such exemplary CNT surface functionalization process may provide chemical and structural stability for the respective electrodes and surface hydrophilicity. These functionalized CNT electrodes may then be assembled into an exemplary device and used to measure the ionic concentrations and/or pH of aqueous solutions.

Exemplary carbon nanostructures on a substrate according to embodiments of the present subject matter may be employed as a sensor to detect analytes in a fluid. Analytes of interest may include, but are not limited to, free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, and combinations thereof.

Exemplary carbon nanostructures may be, but are not limited to, fullerenes, nanowires, nanorods, nanotubes, branched nanowires, nanotetrapods, nanotripods, nanohorns, nanobipods, nanocrystals, nanodots, nanoparticles, nanoribbons, 2D graphene structures, 3D graphene structures, SWCNTs, MWCNTs, conductive, semi-conductive, or insulated CNTs, and chiral, achiral, open headed, capped, budded, coated, uncoated, functionalized, anchored, or unanchored CNTs, and combinations thereof. For example, an auxiliary electrode, a reference electrode, and a working or sensing electrode any of which comprise exemplary carbon nanostructures fabricated according to embodiments of the present subject matter may be exposed to a solution with an electrochemically active analyte of interest. A voltage may then be applied between the working electrode and the reference electrode for a suitable period of time or continuously whereby a current can be generated between the working electrode and the auxiliary electrode. Current generated as a result of the application of voltage may then be measured, and the analyte concentration and/or pH in the sample solution determined using methods described above. Such an exemplary electrode may resist non-specific adsorption and fouling on the electrode surface leading to an electrode possessing long-term stability.

In another aspect, an exemplary method may be provided to detect electrochemical species in a fluid. The method may include applying a voltage between a working or sensing electrode and a reference electrode to produce a current between the sensing electrode and an auxiliary electrode where the working electrode may include exemplary carbon nanostructures produced via a layer-by-layer process. In one embodiment, the carbon nanostructures may include an alkyl moiety layer adjacent the nanostructure surface and a second layer with various functionalities on top of the first layer whereby measured current may be proportional to a concentration of the electrochemical species in the fluid.

In a further aspect, an exemplary method may be provided for detecting electrochemical species in an aqueous fluid. The method may include forming a solution comprising said aqueous fluid and a reagent and contacting a working or sensing electrode, an auxiliary electrode, and a reference electrode with the solution. An exemplary sensing electrode may include fullerene nanostructures as described herein. The method may further include applying a voltage between the sensing electrode and the reference electrode to generate a current between the working electrode and the auxiliary electrode. This current may be measured and correlated to an amount of the electrochemical species present in the fluid. Exemplary electrochemical species include, but are not limited to, free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, to name a few.

Exemplary sensing or working electrodes according to embodiments of the present subject matter may be, but are not limited to, any carbon-forming electrode made of carbon nanotubes, single walled or multi-walled nanotubes, carbon nanotube pastes, glassy carbon or highly ordered basal plane pyrolytic graphite, highly ordered edge plane pyrolytic graphite, graphene or fullerene nanostructures, conductive diamond formed via thermal chemical vapor deposition, arc discharge process, laser-ablation process, natural, incidental and controlled flame environments, plasma enhanced chemical vapor deposition, a capacitively coupled microwave plasma process, a capacitively coupled electron cyclotron resonance process, a capacitively coupled radiofrequency process, an inductively coupled plasma process, a dc plasma assisted hot filament process, template synthesis, carbo thermal carbide conversion, and/or any combination thereof.

An exemplary CNT electrode may include one or more nodes of a CNT or an ensemble of CNTs connected to the conductive layer on the substrate. Each node may be in various dimensions ranging from, for example, 1 nm² to an ensemble of CNTs several cm² in any geometric shape (e.g., bands, circles, grids, loops, meshes, rectangles, squares, stripes, or their combinations, etc.). Of course, the length of CNTs may vary from tens of microns to sub-microns. The CNT sensing electrode may also include an array of nodes that vary from a few nodes to as many as hundreds of thousands of nodes with or without a pitch (i.e., distance between the center of neighboring nodes) ranging from sub-microns to several thousands of microns.

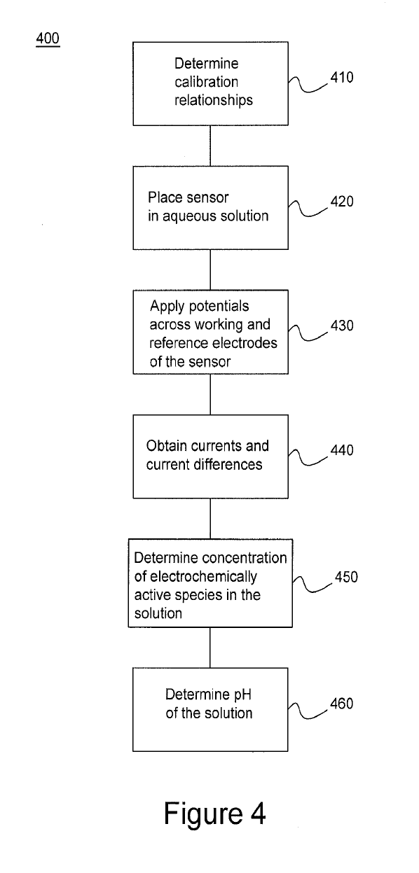

FIG. 4 is a block diagram of one embodiment of the present subject matter. With reference to FIG. 4, a method 400 is provided for determining concentration of an electrochemically active species in a fluid and pH of the fluid. The method 400 at step 410 includes determining a plurality of sets of calibration relationships for a sensor, the sensor having one or more working electrodes and one or more reference electrodes. In a further embodiment, the working electrode may include an array of carbon nanotube electrodes functionalized with an alkyl protective layer and a second layer comprising a bipolar molecule with functional groups or functional moieties. In one embodiment, step 410 may include placing the sensor in one or more solutions, each solution having a known concentration of an electrochemically active species and a known pH and then applying a second plurality of potentials across the working and reference electrodes of the sensor while the sensor is in these solutions. Currents and current differences may then be obtained from this application of potentials and a plurality of sets of calibration relationships determined as a function of these obtained currents and current differences. In a further embodiment, step 410 may include determining a plurality of sets of calibration curves from the obtained currents and current differences and then determining a plurality of sets of calibration equations as a function of the obtained currents and current differences.

At step 420, the sensor may be placed in an aqueous solution, and a first plurality of potentials may be applied across the working and reference electrodes of the sensor at step 430. In one embodiment, step 420 may include applying the first plurality of potentials to plural working electrodes continuously. In another embodiment, step 420 may include applying the first plurality of potentials in sequence to a single working electrode in a cyclical fashion. At step 440, a first plurality of currents and current differences may be obtained as a function of the applied first plurality of potentials. In one embodiment, steps 430 and 440 may be performed cyclically using the one or more working electrodes at the first plurality of potentials. In another embodiment, steps 430 and 440 may be performed simultaneously using a plurality of working electrodes at the first plurality of potentials.

At step 450, concentration of an electrochemically active species may then be determined as a function of the obtained first plurality of currents and current differences using the plural sets of calibration relationships. Exemplary electrochemically active species may be, but are not limited to, free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, and combinations thereof. In one embodiment, step 450 may include determining the concentration of an electrochemically active species as a function of the selection of one of the sets of calibration relationships where all roots are equal. In such an embodiment, the step of determining pH of the solution may include associating the selected set of calibration relationships with a pH. At step 460, pH of the solution may be determined as a function of the obtained first plurality of currents and current differences using the plural sets of calibration relationships.

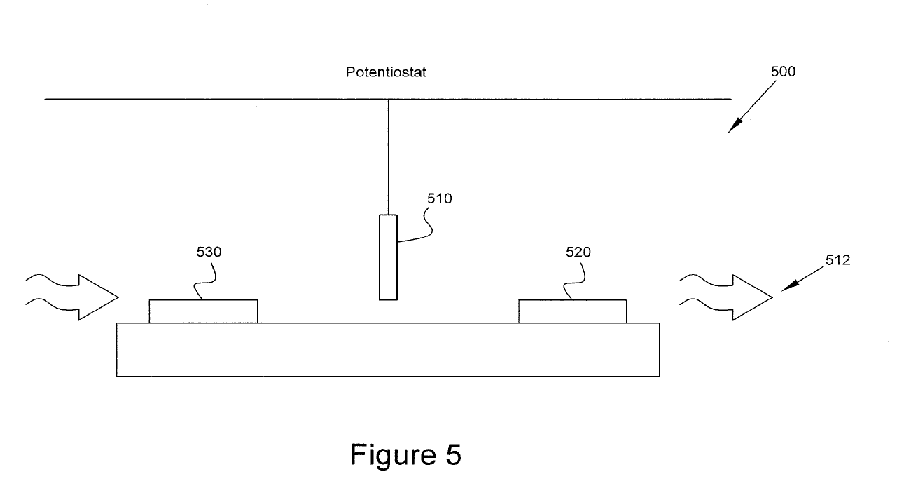

FIG. 5 is a schematic illustration of an exemplary sensor according to one embodiment. With reference to FIG. 5, a device 500 is provided for measuring an electrochemical species in a fluid and pH of the fluid. The device 500 may include a reference electrode 510 in communication with the fluid 512, an auxiliary electrode 520, and a sensing or working 530 electrode in communication with the fluid. The sensing or working electrode 530 may include one or more carbon nanostructures functionalized with a chemically stable moiety that measures concentration of an electrochemical species when a potential is applied across the reference and sensing electrodes to thereby provide a current between the sensing and auxiliary electrodes, the current correlating to the concentration of the electrochemical species and to the pH of the fluid. An exemplary electrochemically active species may be, but is not limited to, free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, and combinations thereof. In one embodiment, the sensing may include an array of carbon nanostructures. Such nanostructures may be comprised of a first layer having an alkyl protective moiety such as, but not limited to, linear alkanes, branched alkanes, alkenes, alkenes containing 10 to 50 carbon atoms, alkenes substituted with one or more halogen atoms, n-octadecane, n-dodecane, eicosane and hexatriacontane, and combinations thereof. A second layer may also be provided on the carbon nanostructure, the second layer having a bipolar molecule with functional groups or functional moieties. In one embodiment, the carbon nanostructure may be a CNT structure including one or more nodes having dimensions in the range of approximately 1 nm² to approximately 1 cm². These nodes may be arranged in any geometric pattern such as, but not limited to, bands, circles, grids, loops, meshes, rectangles, squares, stripes, and combinations thereof. In a further embodiment, the sensing electrode may include an array of CNTs on a substrate where the array of CNTs are microelectrode nodes. The dimensions of these microelectrode nodes may range from sub-microns to several hundred microns. Additionally, the microelectrode nodes may be elevated from the substrate surface.

One exemplary CNT-based chronoamperometric sensor may be employed to continuously monitor solution pH and/or ionic concentration in a fluid or other environment. Such a system may include a processing unit wirelessly (or via wire-line) coupled to the sensor and at least one communication unit being configured to operate in conjunction with the sensor to monitor the fluid. Of course, the communication unit may be configured to report sensor measurements and other data to a remote communication device, which may transmit this information to a user, server, processor, etc. Thus, embodiments of the present subject matter including any type of sensor or combinations thereof may include some form of real-time remote monitoring and reporting of fluidic values in an environment.

An additional embodiment of the present subject matter may have utility in a pH and/or ionic monitoring and control system. Such a system may include one or more CNT-based sensors (voltammetric, potentiometric, amperometric, chronoamperometric, etc.) located within a water system or within a part of a water device being monitored. The sensor may include appropriate measurement circuitry to measure current between electrodes, conversion circuitry (if necessary) to convert analog measurement signals into digital signals, a transceiver or transmitter to wirelessly (or via wire-line) provide these digital signals to a remote location, device, processor, etc. for a real-time or delayed analysis of the water system. An exemplary system may also include control circuitry for controlling the pH and/or chlorine concentration, for example, in the respective water system based on such data analysis from the centralized unit to maintain the proper pH and ionic concentration in the water system and/or to determine whether the applicable dosing units are functioning properly.

As exemplary CNT sensors according to embodiments of the present subject matter are suitable for long-term continuous monitoring while requiring no routine calibration and maintenance, water quality measurements may be gathered in real time. Such real-time data, whether in the form of raw data or analyzed results, of water quality in a respective water distribution system may improve system performance and reduce costs. In municipal, industrial, commercial, and residential applications, the need to remotely monitor water treatment systems and devices has also increased dramatically to ensure water treatment systems or device are operating properly and providing water of a certain quality. Therefore, it is an aspect of embodiments of the present subject matter to provide a monitoring, feedback and/or control system having one or more CNT-based sensors located within a water system or portion thereof. Through the data measured and provided by such sensors, appropriate circuitry may be employed to control and monitor the pH and/or ionic concentration of the respective system to assure compliance with water quality standards.

Additionally, data, commands and other information or messages may be sent or received, wirelessly or via wire-line depending upon the application, from or to various electrodes and/or sensors utilizing an exemplary system. For example, an exemplary monitoring system may collect information from a sensor monitoring the pH of a remote or local fluid system and may provide such information to a user or to a database for real-time or stored use. Further, an exemplary monitoring system may collect information transmitted wirelessly from an intracorporeal sensor or matrix of sensors or electrodes. Such provision (i.e., transmission) of information may be via any known mode of transmission (e.g., wireless or wire-line, as applicable). Such information may also be provided directly to a user or may be provided to a user via a processor for manipulation and/or storage thereof. Of course, the processor and supporting systems may also be employed to provide messages and/or commands to the remote or local sensor or electrode as the need arises. Thus, it is envisioned that embodiments may be implemented using a general purpose computer programmed in accordance with the principals discussed herein. It is also envisioned that embodiments of the subject matter and the functional operations described in this specification may be implemented in or utilize digital electronic circuitry, or in computer software, firmware, or hardware, including the structures disclosed in this specification and their structural equivalents, or in combinations of one or more of them. Thus, embodiments of the subject matter described in this specification can be implemented in or utilize one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

To note, the term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Of course, the general processes described by monitoring systems herein may be performed by one or more programmable processors executing one or more computer programs to perform functions by operating on input data and generating output. These processes may also be performed by special purpose logic circuitry, e.g., a field programmable gate array (FPGA) or an application specific integrated circuit (ASIC). Processors suitable for the execution of an exemplary computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, exemplary systems according to embodiments of the subject matter may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification may also be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system may be interconnected by any form or medium of digital data communication, e.g., a communication network. Examples of communication networks include a local area network (LAN) and a wide area network (WAN), e.g., the Internet. The computing system may also include clients and servers as the need arises. A client and server are generally remote from each other and typically interact through a communication network. The relationship of client and server arises by virtue of computer programs running on the respective computers and having a client-server relationship to each other.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of the claimed subject matter, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

As shown by the various configurations and embodiments illustrated in FIGS. 1-5, multiple potential based chronoamperometric free chlorine sensors have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A chronoamperometric method of determining concentration of an electrochemically active species in a fluid and pH of the fluid comprising the steps of:
(a) determining a plurality of sets of calibration relationships for a sensor, the sensor having one or more working electrodes and one or more reference electrodes;
(b) placing the sensor in an aqueous solution;
(c) applying a first plurality of potentials across the working and reference electrodes of the sensor in solution;
(d) obtaining a first plurality of currents and current differences as a function of the applied first plurality of potentials;
(e) determining concentration of an electrochemically active species as a function of the obtained first plurality of currents and current differences using the plural sets of calibration relationships; and
(f) determining pH of the solution as a function of the obtained first plurality of currents and current differences using the plural sets of calibration relationships.

2. The method of claim 1 wherein the step of determining a plurality of sets of calibration relationships further comprises:
(i) placing the sensor in one or more solutions, each solution having a known concentration of an electrochemically active species and a known pH;
(ii) applying a second plurality of potentials across the working and reference electrodes of the sensor;
(iii) obtaining a second plurality of currents and current differences from the application of the second plurality of potentials; and
(iv) determining a plurality of sets of calibration relationships as a function of the obtained second plurality of currents and current differences.

3. The method of claim 2 wherein the step of determining a plurality of sets of calibration relationships further comprises determining a plurality of sets of calibration curves from the obtained second plurality of currents and current differences and then determining a plurality of sets of calibration equations as a function of the obtained second plurality of currents and current differences.

4. The method of claim 1 wherein the step of applying a first plurality of potentials further comprises applying a first plurality of potentials to plural working electrodes continuously.

5. The method of claim 1 wherein the step of applying a first plurality of potentials further comprises applying a first plurality of potentials in sequence to a single working electrode in a cyclical fashion.

6. The method of claim 1 wherein the step of determining the concentration of an electrochemically active species further comprises determining the concentration of an electrochemically active species as a function of the selection of one of the sets of calibration relationships where all roots are equal.

7. The method of claim 6 wherein the step of determining pH of the solution further comprises determining pH of the solution by associating the selected set of calibration relationships with a pH.

8. The method of claim 1 wherein the electrochemically active species is selected from the group consisting of free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, and combinations thereof.

9. The method of claim 1 wherein the working electrode further comprises an array of carbon nanotube electrodes functionalized with an alkyl protective layer and a second layer comprising a bipolar molecule with functional groups or functional moieties.

10. The method of claim 1 wherein steps (c) and (d) are performed cyclically using the one or more working electrodes at the first plurality of potentials.

11. The method of claim 1 wherein steps (c) and (d) are performed simultaneously using a plurality of working electrodes at the first plurality of potentials.

12. A device for measuring an electrochemical species in a fluid and pH of the fluid comprising:
a reference electrode in communication with a fluid;
an auxiliary electrode;
a sensing electrode in communication with the fluid;
wherein the sensing electrode includes one or more carbon nanostructures functionalized with a chemically stable moiety that measures concentration of an electrochemical species when a potential is applied across the reference and sensing electrodes to thereby provide a current between the sensing and auxiliary electrodes, the current correlating to the concentration of the electrochemical species and to the pH of the fluid.

13. The device of claim 12 wherein the electrochemically active species is selected from the group consisting of free chlorine, chloroamine, bromine, chlorine dioxide, potassium permanganate, iodine, ozone, dissolved oxygen, sulfide, sulfite, nitrite, hydrogen peroxide, dopamine, uric acid, ascorbic acid, aminophenol, 1-naphthol, oxidized 3,3′,5,5′-tetramethylbenzidine, quinones, and combinations thereof.

14. The device of claim 12 wherein the sensing electrode further comprises an array of carbon nanostructures.

15. The device of claim 14 wherein the carbon nanostructure further comprises a first layer thereon having an alkyl protective moiety selected from the group consisting of linear alkanes, branched alkanes, alkenes, alkenes containing 10 to 50 carbon atoms, alkenes substituted with one or more halogen atoms, n-octadecane, n-dodecane, eicosane and hexatriacontane, and combinations thereof.

16. The device of claim 15 wherein the carbon nanostructure further comprises a second layer having a bipolar molecule with functional groups or functional moieties.

17. The device of claim 14 wherein the carbon nanostructure is a carbon nanotube structure including one or more nodes having dimensions in the range of approximately 1 nm² to approximately 1 cm².

18. The device of claim 17 wherein the one or more nodes are arranged in a geometric pattern selected from the group consisting of bands, circles, grids, loops, meshes, rectangles, squares, stripes, and combinations thereof.

19. The device of claim 12 wherein the sensing electrode further comprises an array of carbon nanotubes (CNTs) on a substrate, wherein the array of CNTs are microelectrode nodes.

20. The device of claim 19 wherein the dimensions of the microelectrode nodes range from sub-microns to several hundred microns.

21. The device of claim 19 wherein one or more of the microelectrode nodes are elevated from the substrate surface.
